(19) United States
(12) Patent Application Publication
(10) Pub. No.: US 2005/0009656 A1
(43) Pub. Date: Jan. 13, 2005

(54) Chain wheel

(76) Inventors: Artur Preis, Germering (DE); Stefan Belmer, Anzig (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/476,344

(22) PCT Filed: Sep. 3, 2002
(86) PCT No.: PCT/EP02/09850

(30) Foreign Application Priority Data
Nov. 20, 2001 (DE) 201 18 896.1

(51) Int. Cl. F16H 7/06

(52) U.S. Cl. 474/155

(57) ABSTRACT

A chain wheel for a chain drive, in particular for a control drive of an internal combustion engine, comprising a basic body and a gear rim arranged thereon, the basic body and/or said gear rim being produced at least in certain areas thereof from at least one duroplastic material.

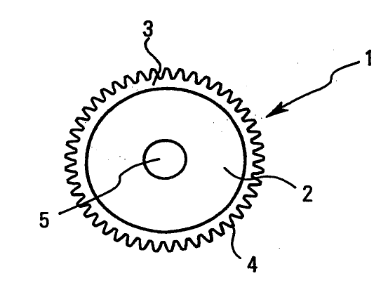

The invention relates to a chain wheel for a chain drive, in particular for a control drive of an internal combustion engine, comprising a basic body and a gear rim arranged thereon.

Especially in the field of timing chain drives of internal combustion engines for motor vehicles, numerous solutions with respect to noise reduction have been suggested within the last few years. In many cases attempts are made to cushion the impact impulse of the chain on the chain wheel by suitable measures. For this purpose, damping and/or spring rings have been developed onto which the links strike when the chain moves onto the chain wheel. Another measure was so conceived that the teeth of the chain wheel were provided with a damping coating. Most of these suggestions fulfil the requirements to be met comparatively well, but part of these suggestions are still comparatively complicated to produce and entail therefore high costs.

It is therefore the object of the present invention to provide a chain wheel of the type mentioned at the beginning, which, in spite of good damping properties, can be produced at a moderate price.

According to the present invention, this object is achieved in that the basic body and/or the gear rim is/are produced at least in certain areas thereof from at least one duroplastic material. At first sight it seems surprising that a material which has been used in other fields has not been taken for such cases of use up to now. As far as chain wheels are concerned, it should, however, be pointed out that thermoplastic materials are normally used for ordinary purposes and that steel is predominantly used in cases where high loads are involved. Presumably, the opinion has prevailed up to now that this group of materials is not suitable for the intended purpose. It is therefore all the more surprising that, making use of duroplastic materials, the inventor succeeded in using this group of materials as a chain wheel for the timing chain drive of an internal combustion engine. In addition to the good noise-reducing properties of such a chain wheel, also the advantages with respect to weight reduction are of primary importance.

Although it is, in principle, possible to produce the basic body and the gear rim from different materials and to connect them in a suitable way, it is preferred when the chain wheel consists fully of at least one duroplastic material. However, combinations of materials could here be used as well, so as to provide suitable duroplastic materials in the various areas of the chain wheel which are subjected to different loads.

In the case of a particularly advantageous variant, the surfaces of the basic body and of the gear rim are formed by a duroplastic-material forming process such that no post-processing steps are required. This means that neither the production of the central opening nor the forming of the teeth will necessitate any additional method steps. The entire shaping is effected by the curing of the duroplastic material.

In this respect, all the surfaces can then be formed by a duroplastic-material forming process such that no post-processing steps are required.

Furthermore, the basic body can comprise a duroplastic material whose damping properties are different from the damping properties of the duroplastic material of the gear rim. The duroplastic material for the gear rim can therefore be chosen such that it has optimum properties for the impact requirements of the chain, whereas the basic body offers a stable base on the one hand and a desired additional damping on the other.

In accordance with a particularly inexpensive embodiment, the basic body and the gear rim are produced from the same duroplastic material.

According to a preferred embodiment, the at least one duroplastic material can be a phenolic resin-based plastic comprising at least one filler. Phenolic resin-based duroplastic materials are very suitable for the main intended purpose, viz. for use in the timing chain drive of an internal combustion engine, and resist the loads occurring in such timing chain drives with respect to the influences caused by lubricants and heat.

In particular, at least one duroplastic material can have a high thermal stability of up to at least 140° C., preferably 160° C. This means that the duroplastic material, including the possibly existing fillers, will maintain its high mechanical properties (e.g. compressive strength, bending strength) also at elevated temperatures (e.g. at 140° C.). These mechanical properties may have the order of the mechanical properties of aluminium materials. Thermoplastic materials begin to flow at such temperature so that suitable countermeasures have to be taken. Such countermeasures can be dispensed with, when duroplastic materials are used. The duroplastic materials suggested here are all capable of resisting high mechanical loads, said loads exceeding by far the load values that can be dealt with by thermoplastic materials.

In addition, the at least one filler may be selected from the following group:
glass fibres, glass balls, mineral matter, graphite, PTFE (Teflon) and MoS₂.

Also combinations of these fillers are imaginable in predetermined mixing ratios. The duroplastic material can, for example, be chosen such that the friction will be reduced or the strength increased. This can also be done only in certain areas of the chain wheel by intentionally influencing the material at the location in question.

It turned out that it will be advantageous to select the at least one duroplastic material from the following group:
X 620
X 655
X 659
X 680
X 681
X 682
X 689
X 6952

Producer: the firm of Vyncolit (Gent, Belgium). It turned out that precisely these duroplastic materials are particularly suitable for use in a timing chain drive of an internal combustion engine and resist the influences caused by temperature and lubricant throughout a long service life.

In the following, an embodiment will be explained in detail making reference to the only Figure.

The Figure shows a chain wheel 1 which is essentially composed of a basic body 2 having the shape of a cylindrical disk, and of an annularly-shaped gear rim 3 arranged on said basic body 2. The outer circumference of the gear rim 3 is normally provided with teeth 4 which are adapted to be brought into engagement with a drive chain of a timing chain drive of an internal combustion engine, said drive chain being not shown. This drive chain is preferably a sleeve-type chain or a roller chain. The basic body is provided with a central axle opening 5 by means of which the chain wheel 1 is arranged on a shaft of the internal combustion engine. The shaft can be a camshaft or a crankshaft. Other drive units may, however, be provided with such a chain wheel 1 as well. The chain wheel 1 is arranged on one of these shafts such that it is secured against rotation relative thereto. Although the whole chain wheel 1 can, in principle, be produced from a uniform duroplastic material, the present embodiment shows a design in the case of which the gear rim 3 and the basic body 2 are produced from different duroplastic materials. It is, however, also possible to establish a chemical-mechanical connection of identical or different materials/types of materials (e.g. a duroplastic support which is chemically-mechanically connected to a thermoplastic coating). In addition, one of these two components may also be produced from a metallic material or from a ceramic material. In the present embodiment, X 689 is used as a material for the gear rim and X 620 is used for the basic body 2. These duroplastic materials can be obtained from the firm of Vyncolit under these product names.

The chain wheel 1 is formed in two successive duroplastic-material forming steps, one of said duroplastic materials being cured in each of said steps. The surfaces are not subjected to post-processing anywhere so that expensive post-forming and post-processing steps can be dispensed with.

The thus produced chain wheel 1 has a particularly low weight and resists the forces occurring in the case of an internal combustion engine and the external influences, especially the influences caused by temperature and lubricant.

1-9. (Cancelled).

10. A chain wheel (1) for a chain drive, in particular for a control drive of an internal combustion engine, comprising a basic body (2) and a gear rim (3) being produced at least in certain areas thereof from at least one duroplastic material, the basic body (2) comprises a duroplastic material whose damping properties are different from the damping properties of the duroplastic material of the gear rim (3).

11. A chain wheel (1) according to claim 10, which consists fully of at least one duroplastic material.

12. A chain wheel (1) according to claim 10, wherein the surfaces of the basic body (2) and of the gear rim (3) are formed by a duroplastic-material forming process such that no post-processing steps are required.

13. A chain wheel (1) according to claim 10, wherein all the surfaces are formed by a duroplastic-material forming process such that no post-processing steps are required.

14. A chain wheel (1) according to claim 10, wherein the at least one duroplastic material is a phenolic resin-based plastic comprising at least one filler.

15. A chain wheel (1) according to claim 14, wherein the at least one duroplastic material has a high thermal stability of up to at least 160° C.

16. A chain wheel (1) according to claim 14, wherein the at least one filler is selected from the following group:
glass fibres
glass balls
mineral matter
graphite
PTFE
MoS₂.

17. A chain wheel (1) according to claim 15, wherein the at least one duroplastic material has a high thermal stability of up to at least 140° C.
